(19) United States
(12) Patent Application Publication
(10) Pub. No.: US 2024/0320472 A1
(43) Pub. Date: Sep. 26, 2024

(54) LOW-POWER AI PROCESSING SYSTEM AND METHOD COMBINING ARTIFICIAL NEURAL NETWORK AND SPIKING NEURAL NETWORK

(71) Applicant: Korea Advanced Institute of Science and Technology, Daejeon (KR)

(72) Inventors: Hoi Jun YOO, Daejeon (KR); Seong Yon HONG, Daejeon (KR)

(73) Assignee: Korea Advanced Institute of Science and Technology, Daejeon (KR)

(21) Appl. No.: 18/613,117

(22) Filed: Mar. 22, 2024

(30) Foreign Application Priority Data
Mar. 23, 2023 (KR) 10-2023-0037999

(51) Int. Cl. G06N 3/045; G06N 3/049

(52) U.S. Cl. CPC G06N 3/045; G06N 3/049

(57) ABSTRACT

A low-power artificial intelligence (AI) processing system combining an artificial neural network (ANN) and a spiking neural network (SNN) includes an ANN including an artificial layer, an SNN configured to output an artificial layer of the ANN as the same operation result, a main controller configured to calculate an ANN computational cost and an SNN computational cost for each artificial layer, an operation domain selector configured to select an operation domain having a lower computational cost by comparing the ANN computational cost and the SNN computational cost, and an equivalent converter configured to form a combined neural network by converting the artificial layer of the ANN into a spiking layer of the SNN according to selection of an SNN operation domain of the operation domain selector. Therefore, there is no loss of accuracy when compared to the ANN.

### BACKGROUND OF THE INVENTION

### Field of the Invention

The present invention relates to a low-power artificial intelligence (AI) processing system and method combining an artificial neural network (ANN) and a spiking neural network (SNN), and more particularly to a low-power AI processing system and method combining an ANN and an SNN capable of reducing overall computational cost of neural networks by converting an artificial layer into a spiking layer generating the same output and using the spiking layer when computational cost of a layer including an SNN is less than computational cost of each layer including an ANN.

### Description of the Related Art

To apply deep neural network-based AI in practice, a neural network needs to have high accuracy and computational cost for neural network processing needs to be low. Existing neural networks broadly include an ANN and an SNN, and each neural network has a problem in satisfying both conditions.

The ANN may achieve high accuracy through backpropagation-based learning. However, there is a problem of high computational cost since energy-consuming multiplication operations are mainly included.

The SNN has opportunity to have lower computational cost than that of the ANN for the above-mentioned reasons. However, there arises a problem of low accuracy.

Even when the ANN-SNN conversion is used, three major conversion errors (quantization error, truncation error, and residual membrane potential approximation error) occur, making it difficult to obtain an SNN having the same accuracy as that of the ANN.

The quantization error is an error that occurs due to a difference in precision between activation data quantized using the fixed-point method in the ANN and activation data quantized by the number of spikes in the SNN.

The truncation error is an error that occurs since an expression range of activation data limited by the number of time steps in the SNN is narrower than an expression range of activation data limited by the fixed-point method in the ANN.

The residual membrane potential approximation error is an error that occurs since there is a possibility that a membrane potential less than 0 or greater than or equal to a threshold may remain in a last time step depending on the input spike pattern of the SNN, and thus the number of output spikes is different from an expected value.

To reduce these errors, the number of time steps (the number of spikes used for expression of activation data) of the SNN may be increased. However, since an integrate-and-fire (IF) operation of the SNN consumes computational cost proportional to the number of output spikes, computational cost is sacrificed.

In this case, computational cost of the SNN may be greater than that of the ANN. Therefore, there is a need for a new neural network structure and configuration method capable of utilizing low computational cost characteristics of the SNN while maintaining high accuracy of the ANN.
(Non-Patent Literature 1) [1] Maass, W. 1997. Networks of spiking neurons: the third generation of neural network models. Neural networks, 10(9): 1659-1671.
(Non-Patent Literature 2) [2] Masquelier, T.; and Thorpe, S. J. 2007. Unsupervised learning of visual features through spike timing dependent plasticity. PLOS computational biology, 3(2): e31
(Non-Patent Literature 3) [3] Wu, Y.; Deng, L.; Li, G.; Zhu, J.; and Shi, L. 2018. Spatiotemporal backpropagation for training high-performance spiking neural networks. Frontiers in neuroscience, 12: 331.
(Non-Patent Literature 4) [4] Diehl, P. U.; Neil, D.; Binas, J.; Cook, M.; Liu, S.-C.; and Pfeiffer, M. 2015. Fast-classifying, high-accuracy spiking deep networks through weight and threshold balancing. In 2015 International joint conference on neural networks (IJCNN), 1-8. ieee.

### SUMMARY OF THE INVENTION

Therefore, the present invention has been made in view of the above problems, and it is an object of the present invention to provide a low-power AI processing system and method combining an ANN and an SNN having high accuracy and low computational cost at the same time by selectively converting only some layers of the ANN into spiking layers.

It is another object of the present invention to provide a low-power AI processing system and method combining an ANN and an SNN capable of preserving high accuracy of the ANN before conversion using a layer-wise equivalent conversion method that causes output activation values of an artificial layer and a spiking layer to be completely the same.

It is a further object of the present invention to provide a low-power AI processing system and method combining an ANN and an SNN capable of defining an operation method of an SNN so that a multiplication operation of activation and a weight expressed in a fixed-point expression method in an artificial layer becomes an operation equivalent to a weight accumulation operation during a time step in a spiking layer, and eliminating a quantization error, a truncation error, or a residual membrane potential approximation error occurring between output activations when converting from the ANN to the SNN accordingly.

It is a further object of the present invention to provide a low-power AI processing system and method combining an ANN and an SNN capable of obtaining spike sparsity for each layer using an operation domain selection method of analyzing computational costs of an artificial layer and a spiking layer to determine whether to convert a corresponding layer into an SNN, calculating costs of an ANN operation and an SNN operation accordingly to select one of the two operations having a lower cost, and constructing a combined neural network having a low computational cost while maintaining accuracy of the ANN by using the artificial layer or the spiking layer equivalently converted from the artificial layer as each layer of a neural network as a result.

In accordance with an aspect of the present invention, the above and other objects can be accomplished by the provision of a low-power artificial intelligence (AI) processing system combining an artificial neural network (ANN) and a spiking neural network (SNN) including an ANN including an artificial layer, an SNN configured to output an artificial layer of the ANN as the same operation result, a main controller configured to calculate an ANN computational cost and an SNN computational cost for each artificial layer, an operation domain selector configured to select an operation domain having a lower computational cost by comparing the ANN computational cost and the SNN computational cost, and an equivalent converter configured to form a combined neural network by converting the artificial layer of the ANN into a spiking layer of the SNN according to selection of an SNN operation domain of the operation domain selector.

The equivalent converter may include a truncation error eliminator configured to set a number of time steps of the spiking layer, set a threshold to reduce a quantization error, and eliminate a truncation error, a quantization error eliminator configured to eliminate a quantization error by adding half the threshold to an initial membrane potential of all neurons in the spiking layer, and a residual membrane potential error eliminator configured to eliminate a residual membrane potential error by collectively exporting all output spikes as a value of a number of spikes at a last time step of the spiking layer.

The equivalent converter may convert an ANN using input and weight data expressed by a fixed-point method into a spiking layer configured to perform an arithmetically equivalent operation.

The equivalent converter may sequentially apply half-threshold initialization through the quantization error eliminator after precision matching through the truncation error eliminator.

The number of spikes may be a quotient obtained by dividing a membrane potential accumulated over a total number of time steps by the threshold.

The main controller may calculate the ANN computational cost by calculating an artificial layer average computational energy Avg(E_{A}).

The main controller may calculate the artificial layer average computational energy Avg(E_{A}) using an equation Avg(E_{A})=(1−s_{A})(Eₘᵤₗ+E_{add}) that adds multiplicative computational energy Eₘᵤₗ and additive computational energy E_{add} to a value obtained by subtracting ANN sparsity S_{A} from “1.”

The main controller may calculate the SNN computational cost by calculating spiking layer average computational energy Avg(E_{S}).

The main controller may calculate the spiking layer average computational energy Avg(E_{S}) using an equation Avg(Eₛ)=(1−sₛ)TE_{add} that adds a number of time steps T and additive computational energy E_{add} to a value obtained by subtracting SNN sparsity S_{S} from “1.”

In accordance with another aspect of the present invention, there is provided a low-power AI processing method combining an ANN and an SNN, the low-power AI processing method comprising steps of (a) receiving a plurality of pieces of input data by a data transceiver, (b) sampling, by a main controller, the input data, performing ANN forward propagation on an input data sample to obtain an intermediate activation value, and analyzing sparsity of each intermediate activation value, (c) calculating, by the main controller, an ANN computational cost and an SNN computational cost based on the sparsity, (d) comparing the ANN computational cost and the SNN computational cost by an operation domain selector, (e) selecting a spiking layer or selecting an artificial layer by the operation domain selector according to a result of the step (d), and (f) forming, by the main controller, a combined neural network combining the spiking layer and the artificial layer, and performing forward propagation of the combined neural network.

In the step (b), the main controller may calculate artificial layer sparsity S_{A} indicating sparsity of an activation data value in the ANN using an equation

$${S}_{A} = \frac{{\sum }_{n} int ( {a}^{l - 1} [ n ] = 0 )}{{NM}^{l - 1}}$$

that divides a number of pieces of data having a value of “0” in total activation data by a number of pieces of the total activation data.

In the step (b), the main controller may calculate spiking layer sparsity S_{S} indicating spike sparsity in the SNN S using an equation

$${S}_{S} = \frac{{\sum }_{n} int ( T - {a}^{l - 1} [ n ] / {θ}^{l} )}{{TNM}^{l - 1}}$$

that divides a number of time steps in which no spike occurs in an entire spike train corresponding to activation data by a total spike data size.

The low-power AI processing method may further include a step of (e-1) converting, by an equivalent converter, the artificial layer into a spiking layer through a layer-wise equivalent conversion algorithm when the spiking layer is selected since the SNN computational cost is less than the ANN computational cost in the step (e).

The step (e-1) may include steps of (e-1-1) performing precision matching to set a number of time steps and a threshold of the spiking layer by a truncation error eliminator of the equivalent converter, and (e-1-2) performing half-threshold initialization to set a bias of the spiking layer by adding half of the threshold to a bias of the artificial layer and set a weight of the spiking layer as a learned weight of the artificial layer without change by a quantization error eliminator of the equivalent converter.

The low-power AI processing method may further include a step of (e-2) maintaining a corresponding layer as the artificial layer in the step (e) by the operation domain selector when the SNN computational cost is greater than the ANN computational cost.

The step (f) may include (f-1) identifying a type of each layer included in the combined neural network by the main controller, (f-2) initializing a membrane potential to set an initial value of the membrane potential to a bias by the main controller when a layer is the spiking layer in the step (f-1), (f-3) generating, by the main controller, an input spike from input based on a number of spikes, (f-4) accumulating, by the main controller, the membrane potential by adding a value obtained by performing a convolution operation of the input spike and a weight to the membrane potential, (f-5) determining whether the main controller is a last time step, (f-6) generating a batch spike by a residual membrane potential error eliminator of the equivalent converter in a case of the last time step in step (f-5), and (f-7) determining, by the main controller, whether the spiking layer or the artificial layer is a last layer in a forward propagation process of the combined neural network, and ending the forward propagation process or repeatedly performing the step (f-1) and steps subsequent thereto.

The low-power AI processing method may further include a step of (f-2′) generating, by the main controller, output activation data as in an existing ANN forward propagation process when the corresponding layer in the artificial layer in the step (f-1).

In the step (f-3), the main controller may generate an input spike when an input activation value is greater than or equal to a threshold at every time step.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a low-power AI processing system combining an ANN and an SNN according to the present invention;

FIG. 2 is a diagram schematically illustrating a mechanism of the low-power AI processing system combining the ANN and the SNN according to the present invention;

FIG. 3 is a diagram for describing a method and a principle of eliminating a quantization error and a truncation error of the low-power AI processing system combining the ANN and the SNN according to the present invention;

FIG. 4 is a diagram for describing a method and a principle of eliminating a residual membrane potential approximation error in an equivalent conversion method of the low-power AI processing system combining the ANN and the SNN according to the present invention;

FIG. 5 is a flowchart of a low-power AI processing method combining an ANN and an SNN according to the present invention;

FIG. 6 is a flowchart of an operation domain selection method in the low-power AI processing method combining the ANN and the SNN according to the present invention;

FIG. 7 is a flowchart of a forward propagation algorithm of a combined neural network in the low-power AI processing method combining the ANN and the SNN according to the present invention;

FIG. 8 is a diagram illustrating a state in which the artificial layer and the spiking layer are sequentially arranged while exchanging activation values with each other in the low-power AI processing method combining the ANN and the SNN according to the present invention; and

FIG. 9 is a diagram for describing that less computational cost is consumed than that of the ANN or the SNN when a combined neural network of the low-power AI processing system combining the ANN and the SNN according to the present invention is applied to an actual dataset.

### DETAILED DESCRIPTION OF THE INVENTION

Terms or words used in this specification and claims should not be construed as being limited to ordinary or dictionary meanings thereof and need to be interpreted as having meanings and concepts consistent with the technical idea of the present invention based on a principle that an inventor can appropriately define a concept of a term to describe the invention of the inventor in the best way possible.

Therefore, an embodiment described in this specification and a configuration illustrated in the drawings are only one of the most preferred embodiments of the present invention and do not represent the entire technical idea of the present invention, and thus it should be understood that at the time of filing this application, there may be various equivalents and modifications that may replace the embodiment.

Hereinafter, a low-power AI processing system and method combining an ANN and an SNN according to the present invention will be described in detail with reference to the attached drawings.

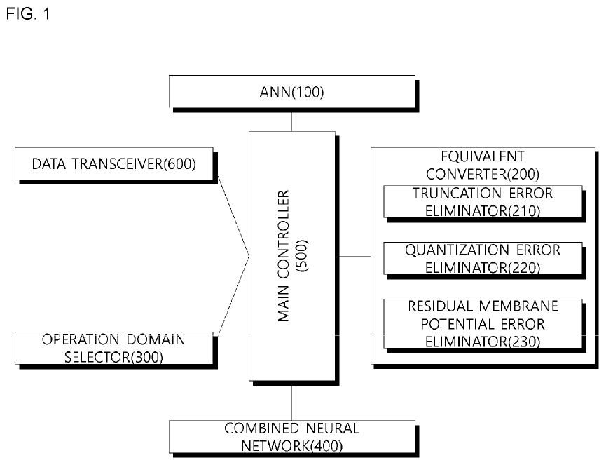

First, as illustrated in FIG. 1, the low-power AI processing system combining the ANN and the SNN according to the present invention includes an ANN 100, an equivalent converter 200, an operation domain selector 300, a combined neural network 400, and a main controller 500, and may further include an SNN S although not illustrated in FIG. 1.

The ANN 100 started by modeling connectivity of biological neurons and became the basis of the AI field. A convolutional neural network (CNN) and a recurrent neural network (RNN), which are representative examples of the ANN 100, exhibit excellent performance in the fields of computer vision and natural language processing, respectively.

However, as the application fields of AI become more sophisticated and the computational cost of ANN also increases, approaches to reduce the computational cost are required.

The equivalent converter 200 converts an artificial layer of the ANN 100 into a spiking layer SL of an SNN S that outputs the same operation result.

The equivalent converter 200 converts the ANN 100, which uses input and weight data expressed in a fixed-point method, into a spiking layer that performs an arithmetically equivalent operation.

A quantization error, a truncation error, and a residual membrane potential approximation error that occur when converting the artificial layer into the spiking layer are all eliminated to ensure that a resultant combined neural network has no decrease in accuracy when compared to the ANN 100.

For reference, the SNN S has been proposed as a method to implement AI with low computational cost by imitating not only connectivity but also behavior of biological neurons.

Each neuron of the SNN S performs a neural network operation using an IF model.

The IF model is a method of multiplying an input spike (0 or 1) from a previous layer by a weight, accumulating a resultant value as a membrane potential, and generating an output spike when the value of the membrane potential exceeds a threshold.

This operation method has the opportunity to reduce computational cost compared to neurons of the ANN 100 for two reasons. First, since an operation is triggered only when an input spike occurs, computational cost is reduced when sparsity of input spikes is high. Second, a multiplication operation of input and a weight in the ANN 100 is replaced by an addition operation of weights in the SNN S, which may cause less computational cost.

Two major methods have been developed to obtain parameters (weight, bias, etc.) required for the above-mentioned SNN S. A first method is direct training, which is a method of training the SNN S from scratch, and is further divided into STDP (Spike-Time-Dependent Plasticity) and BPTT (Backpropagation Through Time) methods.

The STDP method is a method that imitates synaptic plasticity. The STDP method has a problem in that the method has significantly low accuracy and may only be applied to simple applications such as pattern recognition.

The BPTT method is an approximate method that extends a backpropagation (BP) method of the ANN 100 to the time axis, and has higher accuracy than that of the STDP method, but still has lower accuracy than that of the backpropagation method of the ANN.

A second method is ANN 100-SNN conversion, which uses parameters trained by backpropagation in the ANN 100 by converting the parameters into the SNN S.

This method not only more easily obtains parameters than direct training, but also has the highest accuracy among existing SNNs S. Therefore, recently, the ANN-SNN conversion method has become the main method of obtaining SNN parameters.

The basic principle of converting the ANN into the SNN is as follows.

One layer of a typical ANN 100 includes <convolution (or fully connected) layer—batch normalization—ReLU (Rectified Linear Unit) activation function>. The input of the first layer is generally implemented by generating input spikes, the number of which is proportional to an input data value, through rate coding.

The convolution layer operation implements a Multiply-and-Accumulate (MAC) operation by accumulating weights when an input spike occurs during a set time step.

The batch normalization is implemented by adjusting weight and bias values according to batch normalization parameters.

The ReLU activation function is automatically implemented by a characteristic in which no output spike is generated when an accumulated membrane potential is negative. Finally, an output spike is output in approximately proportion to an output activation value of the ANN 100, thereby completing conversion of one layer.

The operation domain selector 300 analyzes the costs of the ANN operation and the SNN operation for each layer in terms of computational energy and selects an operation domain having lower computational cost.

The computational cost of the ANN 100 is constant depending on the data value. However, the computational cost of the SNN S varies depending on the data sparsity.

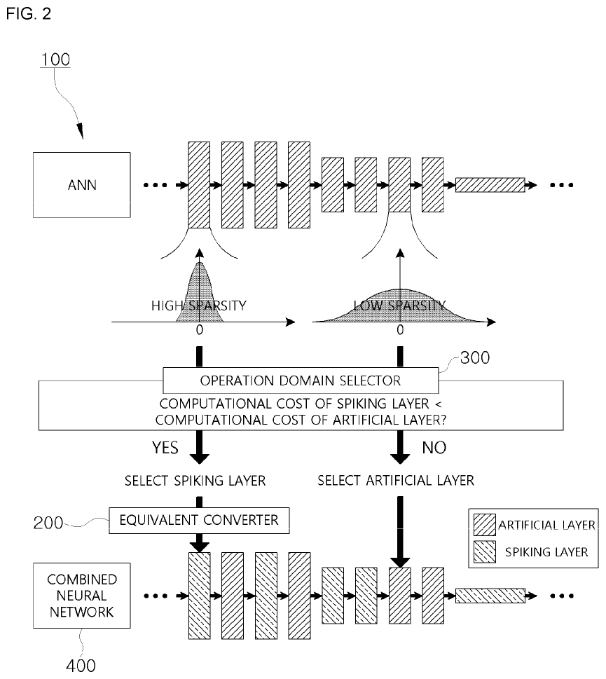

That is, in FIG. 2, when sparsity is high, the computational cost of the spiking layer decreases, and when sparsity is low, the computational cost of the spiking layer increases.

The selection method of the operation domain selector 300 described above is applied to each layer of the neural network, and in the case of a layer having a lower computational cost of the SNN S, a reference artificial layer is converted into a spiking layer through the equivalent converter 200, thereby finally generating the combined neural network 400.

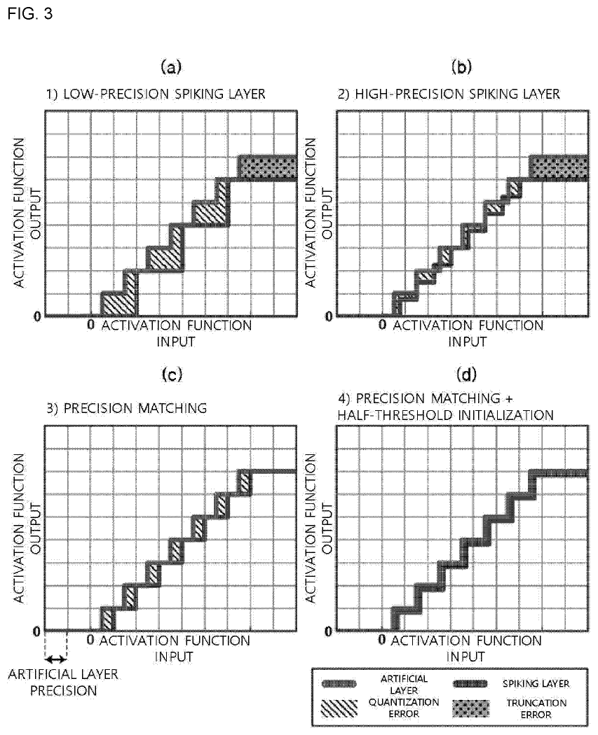

The equivalent converter 200 includes a truncation error eliminator 210, a quantization error eliminator 220, and a residual membrane potential error eliminator 230, and elimination of the truncation error and elimination of the quantization error by the truncation error eliminator 210 and the quantization error eliminator 220 will be described with reference to FIG. 3.

FIG. 3 illustrates an effect of eliminating the truncation error by a precision matching method and an effect of eliminating the quantization error by a half-threshold initialization method in the equivalent converter 200 through a ReLU activation function graph.

In FIG. 3, in the case of the ANN 100, an X-axis represents a value at a stage after undergoing a convolution (or fully connected) layer and batch normalization and before undergoing an activation function, and a Y-axis represents a final output value after undergoing a ReLU activation function.

In the case of the SNN S, the X-axis represents a total membrane potential value accumulated over the total number of time steps through an integrate operation of input spikes and weights, and the Y-axis represents a value obtained by multiplying the number of spikes generated through a fire operation by a threshold of the corresponding layer.

For reference, the purpose of multiplying the threshold is for setting to the same unit as that of activation of the artificial layer.

When input data of the artificial layer is expressed using a fixed-point method with an integer part length of I bits and a fractional part length of F bits through the precision matching method, the truncation error eliminator 210 of the equivalent converter 200 sets the number of time steps of the spiking layer converted therefrom to 2^{I+F}−1, and sets a threshold to 2^{-F}.

The setting has an effect of reducing the quantization error and completely eliminating the truncation error during ANN-SNN conversion.

As illustrated in FIG. 3A, when precision of the spiking layer is less than precision of the artificial layer, an error occurs between activation function output of the artificial layer and activation function output of the spiking layer, and both the precision error and the truncation error significantly occur.

In addition, as illustrated in FIG. 3B, when precision of the spiking layer is greater than precision of the artificial layer, an error similarly occurs between activation function outputs, and both the precision error and the truncation error may occur.

Here, as illustrated in FIG. 3C, when the precision matching method is applied, possible values of output of the artificial layer and output of the spiking layer are consistent with each other, reducing the quantization error and completely eliminating the truncation error.

However, a rounding-off function is applied as the activation function of the ANN 100 when quantizing the output value, and a rounding-down function according to a rule of an IF model is applied as the activation function of the SNN S when quantizing the output spike, and thus there is a range where the outputs of the ANN and the SNN are different from each other depending on the activation function input.

For this reason, even when the precision matching method is applied, the quantization error still remains, and the quantization error eliminator 220 of the equivalent converter 200 eliminates the quantization error using the half-threshold initialization method.

More specifically, the quantization error eliminator 220 of the equivalent converter 200 adds half a threshold determined by the precision matching method, that is, 2^{-F}/2, to initial membrane potentials of all neurons in the spiking layer converted using the half-threshold initialization method, thereby completely eliminating the quantization error of ANN-SNN conversion.

As described above, the equivalent converter 200 may completely eliminate the truncation error and the quantization error by applying the precision matching method and the half-threshold initialization method together.

As illustrated in the change from FIG. 3C to FIG. 3D, the half-threshold initialization method used by the quantization error eliminator 220 has an effect of moving the activation function of the SNN S by 2^{-F}/2 in a negative direction of the X-axis.

The rounding-off function used to quantize the output of the ANN 100 is also the same as a function obtained by shifting the rounding-down function applied to the IF model of the SNN S by half precision in the negative direction of the X-axis. Therefore, as a result, as illustrated in FIG. 3D, activation function graphs of the artificial layer and the spiking layer completely coincide with each other.

Therefore, as illustrated in FIG. 3D, the equivalent converter 200 completely eliminates the quantization error and the truncation error of ANN-SNN conversion using the precision matching method and the half-threshold initialization method.

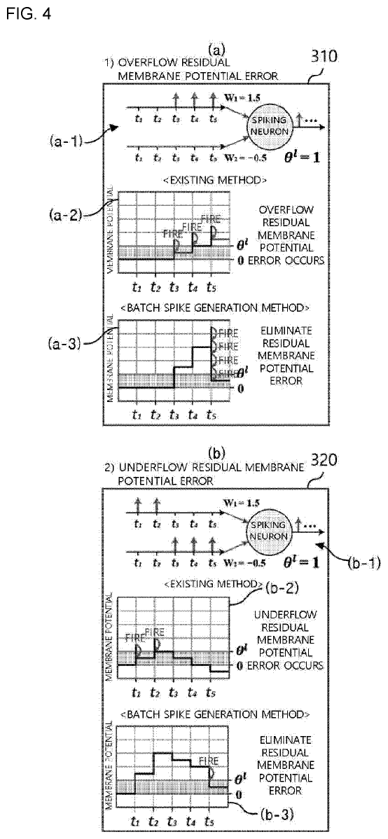

FIG. 4 illustrates, through two examples, a batch spike generation method of eliminating the residual membrane potential approximation error in the layer-wise equivalent conversion method by the residual membrane potential error eliminator 230 of the equivalent converter 200.

The residual membrane potential approximation error is divided into an overflow residual membrane potential approximation error illustrated in FIG. 4A and an underflow residual membrane potential approximation error illustrated in FIG. 4B.

In FIG. 4A, an input spike (a-1) and an overflow residual membrane potential approximation error (a-2) are cases where the residual membrane potential of the spiking layer remains greater than or equal to the threshold, and fewer output spikes than expected are generated.

In FIG. 4B, an input spike (b-1) and an underflow residual membrane potential approximation error (b-2) are cases where the residual membrane potential of the SNN remains less than the threshold, and more output spikes than expected are generated.

The batch spike generation method is a method of collectively exporting all output spikes as a value of the number of spikes at a last time step of the spiking layer.

In this instance, the number of spikes is obtained as a quotient of the accumulated membrane potential over the total number of time steps divided by the threshold.

Since a remainder of the division operation is necessarily greater than or equal to 0 and less than the threshold, this means that the residual membrane potential is greater than or equal to 0 and less than the threshold, and thus no residual membrane potential approximation error occurs. Graphs a-3 and b-3 of FIG. 4 illustrate that no residual membrane potential approximation error occurs when the batch spike generation method is applied in the case where the overflow or underflow residual membrane potential approximation error occurs in the existing IF method.

Hereinafter, as another example, a processing method using the low-power AI processing system combining the ANN and the SNN according to the present invention having the above-described configuration will be described.

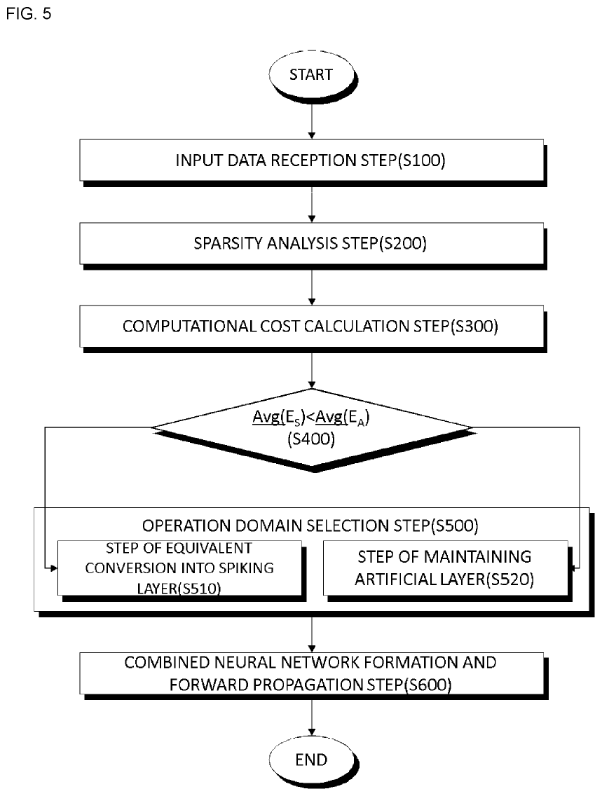

A data transceiver 600 of the low-power AI processing system combining the ANN and the SNN according to the present invention performs a step of receiving a plurality (N) pieces of input data as illustrated in FIG. 5 (S100).

Thereafter, the main controller 500 performs a step of sampling input data received by the data transceiver 600, performing ANN forward propagation on input data samples to obtain intermediate activation values, and analyzing sparsity of each intermediate activation value (S200).

The main controller 500 calculates artificial layer sparsity S_{A}, which represents sparsity of an activation data value in the ANN 100, through the following [Equation 1].

$${S}_{A} = \frac{{\sum }_{n} int ( {a}^{l - 1} [ n ] = 0 )}{{NM}^{l - 1}} \qquad [ Equation 1 ]$$

In [Equation 1], a, I, N, M, and n denote an input activation vector, an index of the corresponding layer, a size of an input data sample, a size of the input activation vector, and an index of the input data sample, respectively.

As can be seen through [Equation 1], the artificial layer sparsity S_{A} is obtained by dividing the number of pieces of data having a value of “0” in the total activation data by the number of pieces of the total activation data.

In addition, the main controller 500 calculates spiking layer sparsity S_{S}, which indicates spike sparsity in the SNN S, through the following [Equation 2].

$${S}_{S} = \frac{{\sum }_{n} int ( T - {a}^{l - 1} [ n ] / {θ}^{l} )}{{TNM}^{l - 1}} \qquad [ Equation 2 ]$$

In the equation, a, I, T, N, M, n, and θ denote an input activation vector, an index of the corresponding layer, the number of time steps, a size of an input data sample, a size of the input activation vector, an index of the input data sample, and a threshold, respectively.

As can be seen through [Equation 2], the spiking layer sparsity S_{S} is obtained by dividing the number of time steps in which no spike occurs in the entire spike train corresponding to activation data by a total spike data size.

Thereafter, the main controller 500 performs a step of calculating the computational costs of the artificial layer and the spiking layer based on the analyzed sparsity (S300).

More specifically, the main controller 500 calculates artificial layer average computational energy Avg(E_{A}) corresponding to the computational cost of the ANN using the following [Equation 3].

$$A v g ( {E}_{A} ) = ( 1 - {s}_{A} ) ( {E}_{mid} + {E}_{add} ) \qquad [ Equation 3 ]$$

As can be seen through [Equation 3], the main controller 500 calculates the artificial layer average computational energy Avg(E_{A}) by adding multiplicative computational energy Eₘᵤₗ and additive computational energy E_{add} to a value obtained by subtracting ANN sparsity S_{A} from “1.”

A reason therefor is that an ANN operation requires one multiplication operation and one addition operation for each non-zero value.

Next, the main controller 500 calculates spiking layer average computational energy Avg(E_{S}) corresponding to the computational cost of the SNN using the following [Equation 4].

$$Avg ( {E}_{s} ) = ( 1 - {s}_{s} ) T {E}_{add} \qquad [ Equation 4 ]$$

As can be seen through [Equation 4], the main controller 500 calculates the spiking layer average computational energy Avg(E_{S}) by adding the number of time steps T and the additive computational energy E_{add} to a value obtained by subtracting the SNN sparsity S_{S} from “1.”

A reason therefor is that an SNN S operation requires one addition operation per spike.

When the main controller 500 calculates the ANN computational cost and the SNN computational cost in each layer by calculating the artificial layer average computational energy Avg(E_{A}) and the spiking layer average computational energy Avg(E_{S}) through [Equation 3] and [Equation 4] as described above, the operation domain selector 300 performs a step of comparing Avg(E_{A}) and Avg(E_{S}) (S400).

The operation domain selector 300 performs a step of selecting a spiking layer or selecting an artificial layer according to the SNN computational cost and the ANN computational cost through the comparison in S400 (S500).

That is, when the operation domain selector 300 selects the spiking layer since the SNN computational cost is less than the ANN computational cost, the equivalent converter 200 performs a step of converting the artificial layer into the spiking layer through a layer-wise equivalent conversion algorithm (S510).

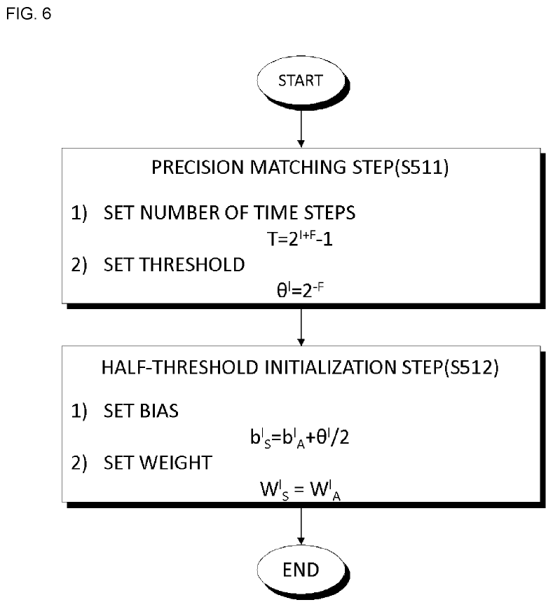

More specifically, as illustrated in FIG. 6, the truncation error eliminator 210 of the equivalent converter 200 performs a precision matching step by setting the number of time steps T of the spiking layer to 2^{I+F}−1 and a threshold θ^{I} to 2^{-F} (S511).

The quantization error eliminator 220 of the equivalent converter 200 performs a half-threshold initialization step by adding half the threshold to a bias of the artificial layer to set a bias of the spiking layer (b^{I}_{S}=b^{I}_{A}+θ^{I}/2), and setting a weight W^{I}_{S} of the spiking layer as a learned weight W^{I}_{A} of the artificial layer without change (S512).

For reference, since the bias is added at a first time step, this is equivalent to adding half the threshold to an initial value of the membrane potential.

The operation domain selector 300 performs a step of maintaining the corresponding layer as the artificial layer when the SNN computational cost is greater than the ANN computational cost (S520).

For reference, various functions such as calculation performed in the equivalent converter 200 or the operation domain selector 300 may also be performed in the main controller 500.

By applying the above-described operation domain selection method to all layers, as a result, the main controller 500 forms a combined neural network that consumes the least computational cost by combining the spiking layer and the artificial layer, and performs a forward propagation step of the combined neural network (S600).

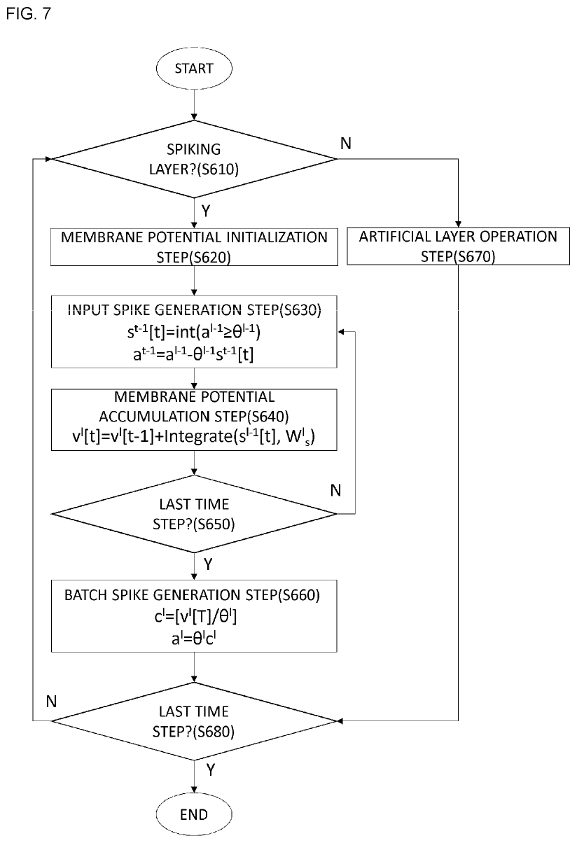

FIG. 7 is a flowchart summarizing a forward propagation process of the combined neural network configured through the operation domain selection algorithm illustrated in FIG. 5.

The following layer-wise forward propagation process is repeated for L layers.

First, the main controller 500 performs a step of identifying a type of each layer included in the combined neural network (S610).

When the corresponding layer is the artificial layer in step S610, the main controller 500 performs a step of generating output activation data in the same manner as the existing ANN forward propagation process (S670).

When the corresponding layer is the spiking layer in step S610, the main controller 500 performs a forward propagation process (S630 to S660) of the spiking layer equivalently converted from the artificial layer.

More specifically, the main controller 500 performs a membrane potential initialization step (v^{I}[0]=b^{I}ₛ) to set the initial value of the membrane potential to a bias (S620).

Then, the main controller 500 repeats the following IF operation for the total number of time steps.

The main controller 500 performs a step of generating an input spike from input based on the number of spikes (S630).

More specifically, the main controller 500 generates an input spike (s^{t-1}[t]=int(a^{I-1}≥θ^{I-1})) when an input activation value is greater than or equal to the threshold at every time step.

In this instance, in step S630, the main controller 500 subtracts the threshold from the input activation value (a^{t-1}=a^{I-1}−θ^{I-1}s^{t-1}[t]).

The main controller 500 performs a step of accumulating the membrane potential (v^{I}[t]=v^{I}[t−1]+Integrate(s^{I-1}[t], W^{I}ₛ)) by adding a value obtained by performing a convolution (or full connection) operation using the input spike and the weight to the membrane potential (S640).

Thereafter, the main controller 500 performs a step of determining whether a last time step is reached (S650).

When the last time step is not reached in step S650, step S630 is repeated, and when the last time step is reached in step S650, the residual membrane potential error eliminator 230 of the equivalent converter 200 performs a step of generating a batch spike as described above (S660).

That is, the residual membrane potential error eliminator 230 of the equivalent converter 200 applies the batch spike generation method to generate output of the layer in the form of the number of spikes (c^{I}=[v^{I}[T]/θ^{I}]), and generates a batch spike by multiplying the number of spikes by the threshold of the corresponding layer (a^{I}=θ^{I}c^{I}) and exporting a resultant value to unify the output and range of the ANN.

The main controller 500 determines whether the spiking layer or the artificial layer is a last layer of the forward propagation process of the combined neural network, and in the case of the last layer, the forward propagation process is ended, and in the case of not being the last layer, step S610 is repeatedly performed.

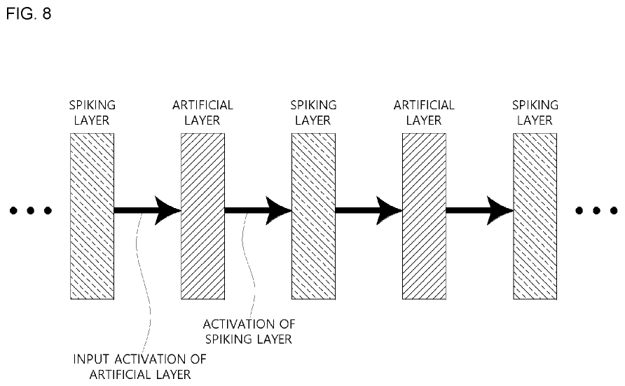

FIG. 8 is an example of a configuration of the combined neural network proposed in the present invention.

This example shows that spiking layers and artificial layers may be alternately included in one neural network. Further, the ANN forward propagation algorithm of FIG. 7 is applied to input activation of the artificial layer, and the SNN forward propagation algorithm of FIG. 7 is applied to input activation of the spiking layer.

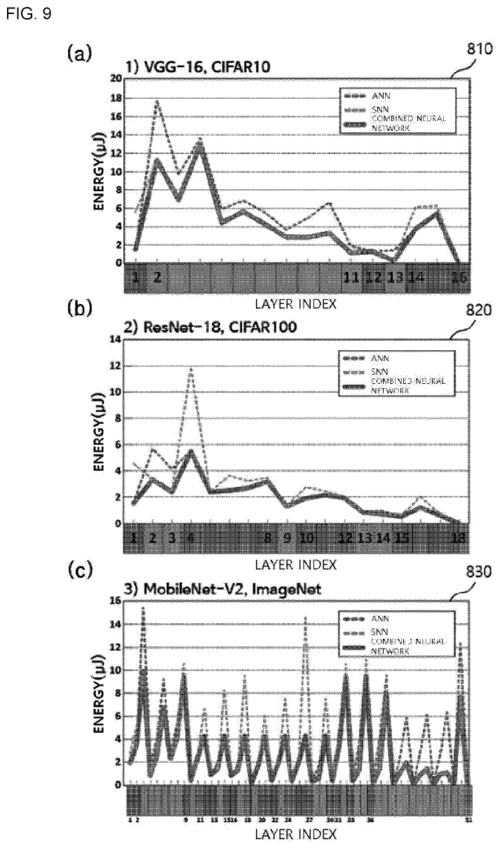

FIG. 9 illustrates a layer configuration and computational energy when the combined neural network of the present invention is applied to an actual neural network architecture and benchmark.

Results when using a VGG-16 neural network and a CIFAR10 benchmark, when using a ResNet-18 neural network and a CIFAR100 benchmark, and when using a MobileNet-V2 neural network and an ImageNet benchmark are representatively illustrated in FIGS. 9A, 9B, and 9C, respectively.

For the ANN, the SNN, and the combined neural network, an X-axis represents an index of each layer, and a Y-axis represents energy consumption of each layer. A configuration of the combined neural network when the operation domain selection method is applied is illustrated in box color at the bottom of the X-axis. (Magenta: artificial layer, cyan: spiking layer)

As a result, the combined neural network consumed the minimum computational cost for all layers regardless of the neural network and the benchmark. When compared in terms of the entire neural network computational energy, the combined neural network consumed 75.4% of energy of the ANN and 90.0% of energy of the SNN as illustrated in FIG. 9A, 88.4% of energy of the ANN and 71.5% of energy of the SNN as illustrated in FIG. 9B, and 76.3% of energy of the ANN and 69.5% of energy of the SNN as illustrated in FIG. 9C.

From the results, it can be seen that the combined neural network follows a layer having the lowest computational cost among the ANN and the SNN and consumes the minimum computational cost compared to the two neural networks.

The low-power AI processing system and method combining the ANN and the SNN according to the present invention has an effect of causing no loss of accuracy when compared to the ANN.

In practice, when accuracy of the low-power AI processing system and method combining the ANN and the SNN according to the present invention was measured on representative image classification datasets CIFAR10, CIFAR100, and ImageNet, the accuracy was 94.13%, 72.78%, and 72.03%, which exactly matches accuracy of the existing ANN.

The low-power AI processing system and method combining the ANN and the SNN according to the present invention has an effect of reducing computational cost when compared to a neural network having only an artificial layer or a spiking layer.

In practice, when measured on the CIFAR10, CIFAR100, and ImageNet datasets, the low-power AI processing system and method combining the ANN and the SNN according to the present invention have an effect of being able to reduce computational cost by up to 47.8% when compared to the ANN and have an effect of being able to reduce computational cost by up to 35.1% when compared to the SNN.

A technical idea of the present invention has been described above along with the accompanying drawings. However, this is an illustrative description of a preferred embodiment of the present invention and does not limit the present invention. In addition, it is clear that anyone skilled in the art of the present invention may make various modifications and imitations without departing from the scope of the technical idea of the present invention.

1. A low-power artificial intelligence (AI) processing system combining an artificial neural network (ANN) and a spiking neural network (SNN), the low-power AI processing system comprising:
an ANN including an artificial layer;
an SNN configured to output an artificial layer of the ANN as the same operation result;
a main controller configured to calculate an ANN computational cost and an SNN computational cost for each artificial layer;
an operation domain selector configured to select an operation domain having a lower computational cost by comparing the ANN computational cost and the SNN computational cost; and
an equivalent converter configured to form a combined neural network by converting the artificial layer of the ANN into a spiking layer of the SNN according to selection of an SNN operation domain of the operation domain selector.

2. The low-power AI processing system according to claim 1, wherein the equivalent converter comprises:
a truncation error eliminator configured to set a number of time steps of the spiking layer, set a threshold to reduce a quantization error, and eliminate a truncation error;
a quantization error eliminator configured to eliminate a quantization error by adding half the threshold to an initial membrane potential of all neurons in the spiking layer; and
a residual membrane potential error eliminator configured to eliminate a residual membrane potential error by collectively exporting all output spikes as a value of a number of spikes at a last time step of the spiking layer.

3. The low-power AI processing system according to claim 2, wherein the equivalent converter converts an ANN using input and weight data expressed by a fixed-point method into a spiking layer configured to perform an arithmetically equivalent operation.

4. The low-power AI processing system according to claim 2, wherein the equivalent converter sequentially applies half-threshold initialization through the quantization error eliminator after precision matching through the truncation error eliminator.

5. The low-power AI processing system according to claim 2, wherein the number of spikes is a quotient obtained by dividing a membrane potential accumulated over a total number of time steps by the threshold.

6. The low-power AI processing system according to claim 1, wherein the main controller calculates the ANN computational cost by calculating an artificial layer average computational energy Avg(E_{A}).

7. The low-power AI processing system according to claim 6, wherein the main controller calculates the artificial layer average computational energy Avg(E_{A}) using an equation Avg(E_{A})=(1−s_{A})(Eₘᵤₗ+E_{add}) that adds multiplicative computational energy Eₘᵤₗ and additive computational energy E_{add} to a value obtained by subtracting ANN sparsity S_{A} from “1.”

8. The low-power AI processing system according to claim 1, wherein the main controller calculates the SNN computational cost by calculating spiking layer average computational energy Avg(E_{S}).

9. The low-power AI processing system according to claim 8, wherein the main controller calculates the spiking layer average computational energy Avg(E_{S}) using an equation Avg(Eₛ) (1−sₛ)TE_{add} that adds a number of time steps T and additive computational energy E_{add} to a value obtained by subtracting SNN sparsity S_{S} from “1.”

10. A low-power AI processing method combining an ANN and an SNN, the low-power AI processing method comprising steps of:
(a) receiving a plurality of pieces of input data by a data transceiver;
(b) sampling, by a main controller, the input data, performing ANN forward propagation on an input data sample to obtain an intermediate activation value, and analyzing sparsity of each intermediate activation value;
(c) calculating, by the main controller, an ANN computational cost and an SNN computational cost based on the sparsity;
(d) comparing the ANN computational cost and the SNN computational cost by an operation domain selector;
(e) selecting a spiking layer or selecting an artificial layer by the operation domain selector according to a result of the step (d); and
(f) forming, by the main controller, a combined neural network combining the spiking layer and the artificial layer, and performing forward propagation of the combined neural network.

11. The low-power AI processing method according to claim 10, wherein, in the step (b), the main controller calculates artificial layer sparsity S_{A} indicating sparsity of an activation data value in the ANN using an equation
$${S}_{A} = \frac{{\sum }_{n} int ( {a}^{l - 1} [ n ] = 0 )}{{NM}^{l - 1}}$$
that divides a number of pieces of data having a value of “0” in total activation data by a number of pieces of the total activation data.

12. The low-power AI processing method according to claim 10, wherein, in the step (b), the main controller calculates spiking layer sparsity S_{S} indicating spike sparsity in the SNN S using an equation
$${S}_{S} = \frac{{\sum }_{n} int ( T - {a}^{l - 1} [ n ] / {θ}^{l} )}{{TNM}^{l - 1}}$$
that divides a number of time steps in which no spike occurs in an entire spike train corresponding to activation data by a total spike data size.

13. The low-power AI processing method according to claim 10, further comprising a step of:
(e-1) converting, by an equivalent converter, the artificial layer into a spiking layer through a layer-wise equivalent conversion algorithm when the spiking layer is selected since the SNN computational cost is less than the ANN computational cost in the step (e).

14. The low-power AI processing method according to claim 13, wherein the step (e-1) comprises steps of:
(e-1-1) performing precision matching to set a number of time steps and a threshold of the spiking layer by a truncation error eliminator of the equivalent converter; and
(e-1-2) performing half-threshold initialization to set a bias of the spiking layer by adding half of the threshold to a bias of the artificial layer and set a weight of the spiking layer as a learned weight of the artificial layer without change by a quantization error eliminator of the equivalent converter.

15. The low-power AI processing method according to claim 10, further comprising a step of:
(e-2) maintaining a corresponding layer as the artificial layer in the step (e) by the operation domain selector when the SNN computational cost is greater than the ANN computational cost.

16. The low-power AI processing method according to claim 10, wherein the step (f) comprises:
(f-1) identifying a type of each layer included in the combined neural network by the main controller;
(f-2) initializing a membrane potential to set an initial value of the membrane potential to a bias by the main controller when a layer is the spiking layer in the step (f-1);
(f-3) generating, by the main controller, an input spike from input based on a number of spikes;
(f-4) accumulating, by the main controller, the membrane potential by adding a value obtained by performing a convolution operation of the input spike and a weight to the membrane potential;
(f-5) determining whether the main controller is a last time step;
(f-6) generating a batch spike by a residual membrane potential error eliminator of the equivalent converter in a case of the last time step in step (f-5); and
(f-7) determining, by the main controller, whether the spiking layer or the artificial layer is a last layer in a forward propagation process of the combined neural network, and ending the forward propagation process or repeatedly performing the step (f-1) and steps subsequent thereto.

17. The low-power AI processing method according to claim 16, further comprising a step of:
(f-2′) generating, by the main controller, output activation data as in an existing ANN forward propagation process when the corresponding layer is the artificial layer in the step (f-1).

18. The low-power AI processing method according to claim 16, wherein, in the step (f-3), the main controller generates an input spike when an input activation value is greater than or equal to a threshold at every time step.
